(19) United States
(12) Patent Application Publication
(10) Pub. No.: US 2019/0325480 A1
(43) Pub. Date: Oct. 24, 2019

(54) INFORMATION PROVIDING DEVICE, INFORMATION PROVIDING SYSTEM, AND INFORMATION PROVIDING METHOD

(71) Applicant: TOYOTA JIDOSHA KABUSHIKI KAISHA, Toyota-shi (JP)

(72) Inventors: Koichi SUZUKI, Miyoshi-shi (JP); Katsunori TAKAMI, Tachikawa-shi (JP)

(73) Assignee: TOYOTA JIDOSHA KABUSHIKI KAISHA, Toyota-shi (JP)

(21) Appl. No.: 16/366,488

(22) Filed: Mar. 27, 2019

(30) Foreign Application Priority Data
Apr. 23, 2018 (JP) 2018-082497

(51) Int. Cl. G06Q 30/02; G01C 21/34

(52) U.S. Cl. CPC G06Q 30/0266; G01C 21/3476

(57) ABSTRACT

An information providing device includes a destination acquisition unit configured to acquire a destination, a sales promotion information acquisition unit configured to acquire sales promotion information including a sales location where sales promotion is performed, a route generation unit configured to generate a route from a departure place toward the destination by way of the sales location within a search range including the departure place and the destination, and present the route to a user, and an instruction unit configured to output an instruction to transmit sales promotion use information for using the sales promotion at the sales location, through which the route passes, to a portable terminal of the user.

### INCORPORATION BY REFERENCE

The disclosure of Japanese Patent Application No. 2018-082497 filed on Apr. 23, 2018 including the specification, drawings and abstract is incorporated herein by reference in its entirety.

### BACKGROUND

### 1. Technical Field

The present disclosure relates to an information providing device, an information providing system, and an information providing method.

### 2. Description of Related Art

A technique that distributes sales promotion information, such as a coupon or an advertisement, to a car navigation device or a portable terminal and presents the sales promotion information to a user in order to guide a customer to a sales location (store or the like) of a commodity or a service is known. For example, Japanese Unexamined Patent Application Publication No. 2012-248073 (JP 2012-248073 A) discloses a system that distributes a coupon usable at a store close to a current position of a user or a coupon or a commodity matching the preference of the user to a portable terminal of the user.

### SUMMARY

However, in the related art, there is a problem in efficiently providing the sales promotion information to the user.

The disclosure provides an information providing device, an information providing system, and an information providing method that efficiently provide sales promotion information to a user.

A first aspect of the disclosure relates to an information providing device. The information providing device includes a destination acquisition unit, a sales promotion information acquisition unit, a route generation unit, and an instruction unit. The destination acquisition unit is configured to acquire a destination. The sales promotion information acquisition unit is configured to acquire sales promotion information including a sales location where sales promotion is performed. The route generation unit is configured to generate a route from a departure place toward the destination by way of the sales location within a search range including the departure place and the destination, and present the route to a user. The instruction unit is configured to output an instruction to transmit sales promotion use information for using the sales promotion at the sales location, through which the route passes, to a portable terminal of the user.

The information providing device according to the first aspect of the disclosure may further include a time acquisition unit configured to acquire a desired arrival time at the destination. The route generation unit may generate the route for enabling arrival at the destination before the desired arrival time.

In the information providing device according to the aspect, the sales promotion information may include an average residence time at the sales location. The time acquisition unit may obtain a scheduled arrival time at the destination based on the average residence time.

In the information providing device according to the first aspect, the sales promotion use information may include a coupon usable at the sales location or an advertisement relating to the sales location.

In the information providing device according to the first aspect, the sales promotion information may include an expiration date. The route generation unit may generate the route to enable arrival at the sales location before the expiration date is reached.

In the information providing device according to the first aspect, in generating the route, the route generation unit may use a sales location where sales promotion corresponding to preference information of the user is performed.

In the information providing device according to the first aspect, in generating the route, the route generation unit may further use a sales location where sales promotion not corresponding to preference of the user is performed.

In the information providing device according to the first aspect, the route generation unit may generate the route to pass through the most passable sales locations.

In the information providing device according to the first aspect, the sales promotion information may include discount information at the sales location. The route generation unit may generate the route such that a sum of discount amounts at the sales locations, through which the route passes, becomes greater.

The information providing device according to the first aspect of the disclosure may further include a determination unit configured to determine that the user has been at the sales location.

In the information providing device according to the first aspect, the destination acquisition unit may obtain the destination based on a movement history of the user.

A second aspect of the disclosure relates to an information providing system. The information providing system includes a portable terminal of a user and an information providing device. The information providing device is configured to perform communication with the portable terminal. The information providing device includes a destination acquisition unit, a sales promotion information acquisition unit, a route generation unit, and an instruction unit. The destination acquisition unit is configured to acquire a destination. The sales promotion information acquisition unit is configured to acquire sales promotion information including a sales location where sales promotion is performed. The route generation unit is configured to generate a route from a departure place toward the destination by way of the sales location within a search range including the departure place and the destination, and present the route to the user. The instruction unit is configured to output an instruction to transmit sales promotion use information for using the sales promotion at the sales location, through which the route passes, to the portable terminal of the user. The portable terminal includes a communication unit. The communication unit is configured to receive the sales promotion use information.

A third aspect of the disclosure relates to an information providing method that is executed by a portable terminal of a user and an information providing device configured to perform communication with the portable terminal. The information providing method includes, with the information providing device, acquiring a destination, acquiring sales promotion information including a sales location where sales promotion is performed, generating a route from a departure place toward the destination by way of the sales location within a search range including the departure place and the destination, and presenting the route to the user, and outputting an instruction to transmit sales promotion use information for using the sales promotion at the sales location, through which the route passes, to the portable terminal of the user; and with the portable terminal, the sales promotion use information is received.

According to the aspects of the disclosure, it is possible to efficiently provide the sales promotion information to the user.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing a configuration example of an embodiment;

FIG. 2 is a diagram showing a detailed configuration example of an information providing device;

FIG. 3 is a diagram showing a configuration example of a sales promotion information distribution device;

FIG. 4 is a diagram showing examples of sales promotion information and sales promotion use information;

FIG. 5 is a sequence diagram showing a procedure example where preference information and the like are transmitted to the information providing device;

FIG. 6A is a sequence diagram showing a procedure example where the information providing device performs route generation;

FIG. 6B is a sequence diagram showing a procedure example where the information providing device performs route generation;

FIG. 7A is a diagram showing an example of route generation;

FIG. 7B is a diagram showing an example of route generation;

FIG. 7C is a diagram showing an example of route generation;

FIG. 8 is a diagram showing a display example of an optimized route;

FIG. 9A is a sequence diagram showing a procedure example where the sales promotion use information is transmitted to a portable terminal;

FIG. 9B is a sequence diagram showing a procedure example where the sales promotion use information is transmitted to the portable terminal;

FIG. 10 is a sequence diagram showing a procedure example where the sales promotion use information is used by the portable terminal;

FIG. 11A is a sequence diagram showing a procedure example where the sales promotion use information is used by the portable terminal;

FIG. 11B is a sequence diagram showing a procedure example where the sales promotion use information is used by the portable terminal;

FIG. 12A is a sequence diagram showing a procedure example in a modification example;

FIG. 12B is a sequence diagram showing a procedure example in a modification example;

FIG. 13 is a diagram showing a modification example; and

FIG. 14 is a diagram showing a modification example.

### DETAILED DESCRIPTION OF EMBODIMENTS

Hereinafter, an embodiment will be described in detail referring to the drawings.

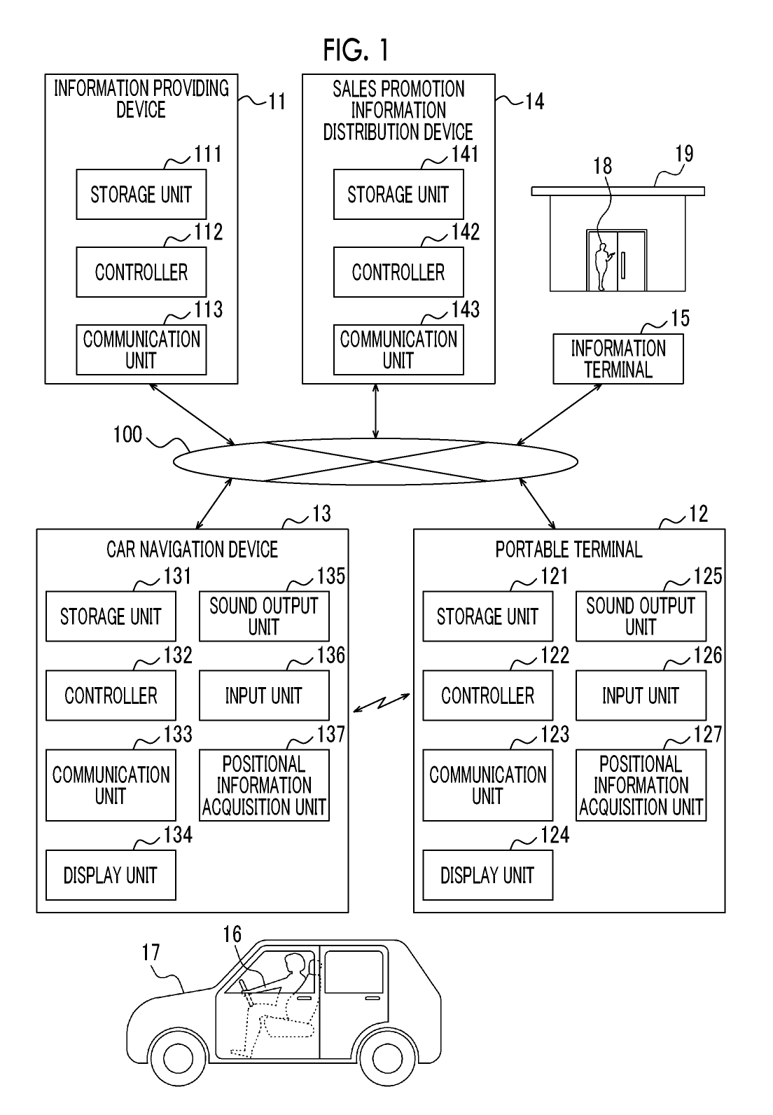

FIG. 1 is a diagram showing a configuration example of the embodiment. In the embodiment, an information providing device 11, a portable terminal 12, a car navigation device 13, a sales promotion information distribution device 14, and an information terminal 15 are connected to perform data communication with one another through a communication network 100. A user 16 carries the portable terminal 12. In a vehicle 17 of the user 16, the car navigation device 13 is mounted. Then, the information terminal 15 is provided at a sales location 19 of a seller 18 of a commodity or a service. The sales location 19 is, for example, a store or an event venue. In the embodiment, an information providing system includes the information providing device 11 and the portable terminal 12.

In such a configuration, the sales promotion information distribution device 14 distributes sales promotion information and sales promotion use information that are used when the seller 18 performs sales promotion of a commodity or a service at the sales location 19. The sales promotion information is sent from the sales promotion information distribution device 14 to the car navigation device 13 through the information providing device 11. The sales promotion use information is sent from the sales promotion information distribution device 14 to the portable terminal 12. The user 16 visits the sales location 19 based on the sales promotion information and purchases a commodity or a service using the sales promotion use information.

The information providing device 11 receives the sales promotion information from the sales promotion information distribution device 14 and transmits the sales promotion information to the car navigation device 13. The information providing device 11 is, for example, a server device. The information providing device 11 includes a storage unit 111, a controller 112, and a communication unit 113.

The storage unit 111 stores a control and processing program relating to a control and processing operation of the information providing device 11. Furthermore, the storage unit 111 temporarily stores various kinds of information in the control and processing operation of the information providing device 11. The storage unit 111 has, for example, a storage medium, such as a memory or an optical or magnetic disk, and a control circuit for the storage medium.

The controller 112 controls the operation of the information providing device 11 according to the control and processing program. The controller 112 has, for example, a general-purpose processor or a dedicated processor specific to specified processing.

The communication unit 113 has a communication interface corresponding to various communication standards and a control circuit for the communication interface. The communication interface corresponds to, for example, a wired local area network (LAN) standard, a wireless LAN standard, and the like. The communication unit 113 is connected to the communication network 100 in a wired or wireless manner. The information providing device 11 can perform data communication with the portable terminal 12, the car navigation device 13, the sales promotion information distribution device 14, and the information terminal 15 through the communication network 100 using the communication unit 113.

The portable terminal 12 is a portable information and communication terminal. The portable terminal 12 receives the sales promotion use information from the information providing device 11. The user 16 carries the portable terminal 12 and uses the sales promotion use information using the portable terminal 12. The sales promotion use information is, for example, an advertisement or a coupon of sales promotion. The user 16 makes the portable terminal 12 display an advertisement of sales promotion to see the sales location 19. The user 16 uses a coupon using the portable terminal 12 when visiting the sales location 19. The portable terminal 12 includes a storage unit 121, a controller 122, a communication unit 123, a display unit 124, a sound output unit 125, an input unit 126, and a positional information acquisition unit 127.

The storage unit 121 stores a control and processing program relating to a control and processing operation of the portable terminal 12. Furthermore, the storage unit 121 temporarily stores various kinds of information for use in the control and processing operation of the portable terminal 12. The storage unit 121 has, for example, a storage medium, such as a memory, and a control circuit for the storage medium.

The controller 122 controls the operation of the portable terminal 12 according to the control and processing program. The controller 122 has, for example, a general-purpose processor or a dedicated processor specific to specified processing.

The communication unit 123 has a communication interface corresponding to various communication standards and a control circuit for the communication interface. The communication interface corresponds to, for example, a mobile communication standard, such as 4th Generation (4G), a short-range wireless communication standard, such as Bluetooth (Registered Trademark), a wired local area network (LAN) standard, a wireless LAN standard, and the like. The communication unit 123 is connected to the communication network 100 in a wireless manner, for example. The portable terminal 12 performs data communication with the information providing device 11, the sales promotion information distribution device 14, and the information terminal 15 through the communication network 100 using the communication unit 123. The portable terminal 12 can perform direct data communication with the car navigation device 13 through short-range wireless communication using the communication unit 123.

The display unit 124 displays a screen data to be generated by the controller 122 or received by the communication unit 123. The display unit 124 has a display and a control circuit for the display. The display is, for example, a panel display, such as a liquid crystal panel or an organic electroluminescence (EL) panel.

The sound output unit 125 outputs data to be generated by the controller 122 or received by the communication unit 123 in a form of sound. The sound output unit 125 has a speaker that outputs sound corresponding to sound data and a control circuit for the speaker.

The input unit 126 has an input interface that receives an input from the user 16 and a control circuit for the input interface. The input interface has, for example, a touch panel integrated with the display unit 124. Furthermore, the input interface has a keyboard that receives a character input, for example. In addition, the input interface has, for example, a microphone that receives a sound input.

The positional information acquisition unit 127 has a global positioning system (GPS) receiver that receives GPS signals from GPS satellites. The controller 122 derives a position (for example, latitude and longitude) of the portable terminal 12 based on the GPS signals received by the positional information acquisition unit 127.

The car navigation device 13 is mounted in the vehicle 17 and assists driving of the vehicle 17 by the user 16. The car navigation device 13 searches for a route from a departure place to a destination input by the user 16, presents the route to the user 16, and guides driving. The car navigation device 13 includes a storage unit 131, a controller 132, a communication unit 133, a display unit 134, a sound output unit 135, an input unit 136, and a positional information acquisition unit 137.

The storage unit 131 stores a control and processing program relating to a control and processing operation of the car navigation device 13, map information, user information, such as a user ID, and the like. Furthermore, the storage unit 131 temporarily stores various kinds of information, such as a position, braking, and a speed, for use in the control and processing operation of the car navigation device 13. The storage unit 111 has, for example, a storage medium, such as a memory or a magnetic or optical disk, and a control circuit for the storage medium.

The controller 132 controls a driving assistance operation of route search and guide of the car navigation device 13 according to the control and processing program. The controller 132 has, for example, a general-purpose processor or a dedicated processor specific to specified processing.

The communication unit 133 has a communication interface corresponding to various communication standards and a control circuit for the communication interface. The communication interface corresponds to, for example, a mobile communication standard, such as 4G, a short-range wireless communication standard, such as Bluetooth (Registered Trademark), a wired LAN standard, a wireless LAN standard, and the like. The communication unit 133 is connected to the communication network 100 through wireless communication. The car navigation device 13 performs data communication with the information providing device 11, the sales promotion information distribution device 14, and the information terminal 15 through the communication network 100 using the communication unit 123. The car navigation device 13 can perform data communication directly with the portable terminal 12 through short-range communication using the communication unit 123.

The display unit 134 displays a screen based on data to be generated by the controller 132 or received by the communication unit 133. The display unit 134 has a display and a control circuit for the display. The display is, for example, a panel display, such as a liquid crystal panel or an organic EL panel. Alternatively, the display is, for example, a head-up display.

The sound output unit 135 outputs data to be generated by the controller 132 or received by the communication unit 133 in a form of sound. The sound output unit 125 has a speaker that outputs sound corresponding to sound data and a control circuit for the speaker.

The input unit 136 receives an input from the user 16. The input unit 136 has an input interface and a control circuit for the input interface. The input interface has, for example, a touch panel integrated with the display unit 134. Furthermore, the input interface has, for example, a keyboard that receives a character input. In addition, the input interface has, for example, a microphone that receives a sound input.

The positional information acquisition unit 137 has a GPS receiver that receives GPS signals from GPS satellites. The controller 132 derives a position (for example, a latitude and a longitude) of the car navigation device 13 based on the GPS signals received by the positional information acquisition unit 137.

The sales promotion information distribution device 14 distributes sales promotion information and sales promotion use information to be issued by the seller 18. For example, the sales promotion information distribution device 14 transmits the sales promotion information to the information providing device 11, and transmits the sales promotion use information to the portable terminal 12. The sales promotion information distribution device 14 is a server device including a storage unit 141, a controller 142, and a communication unit 143.

The storage unit 141 stores a control and processing program relating to a control and processing operation of the sales promotion information distribution device 14. Furthermore, the storage unit 141 temporarily stores various kinds of information in the control and processing operation of the sales promotion information distribution device 14. In addition, the storage unit 141 stores the sales promotion information and the sales promotion use information. The storage unit 141 has, for example, a storage medium, such as a memory or an optical or magnetic disk, and a control circuit for the storage medium.

The controller 142 controls the operation of the sales promotion information distribution device 14 according to the control and processing program. The controller 142 has, for example, a general-purpose processor or a dedicated processor specific to specified processing.

The communication unit 143 has a communication interface corresponding to various communication standards and a control circuit for the communication interface. The communication interface corresponds to, for example, a wired LAN standard, a wireless LAN standard, and the like. The communication unit 143 is connected to the communication network 100 in a wired or wireless manner. The sales promotion information distribution device 14 can perform data communication with the information providing device 11, the portable terminal 12, the car navigation device 13, and the information terminal 15 through the communication network 100 using the communication unit 143.

The information terminal 15 is provided at, for example, the sales location 19. Alternatively, the information terminal 15 is carried with the seller 18. The seller 18 transmits the sales promotion information or the sales promotion use information to the sales promotion information distribution device 14 using the information terminal 15. Furthermore, the information terminal 15 acquires the sales promotion use information from the portable terminal 12 of the user 16 and transmits the sales promotion use information to the sales promotion information distribution device 14. The information terminal 15 is, for example, a personal computer including a reading device of a coupon and an interface that is connected to perform data communication with the communication network 100. Alternatively, the information terminal 15 may be a portable electronic device, such as a smartphone, a mobile phone, or a tablet, including a reading function of a coupon and a data communication function with the communication network 100.

The communication network 100 is, for example, any one of a LAN, a wide area network (WAN), a mobile communication network, and the Internet, or a combination thereof.

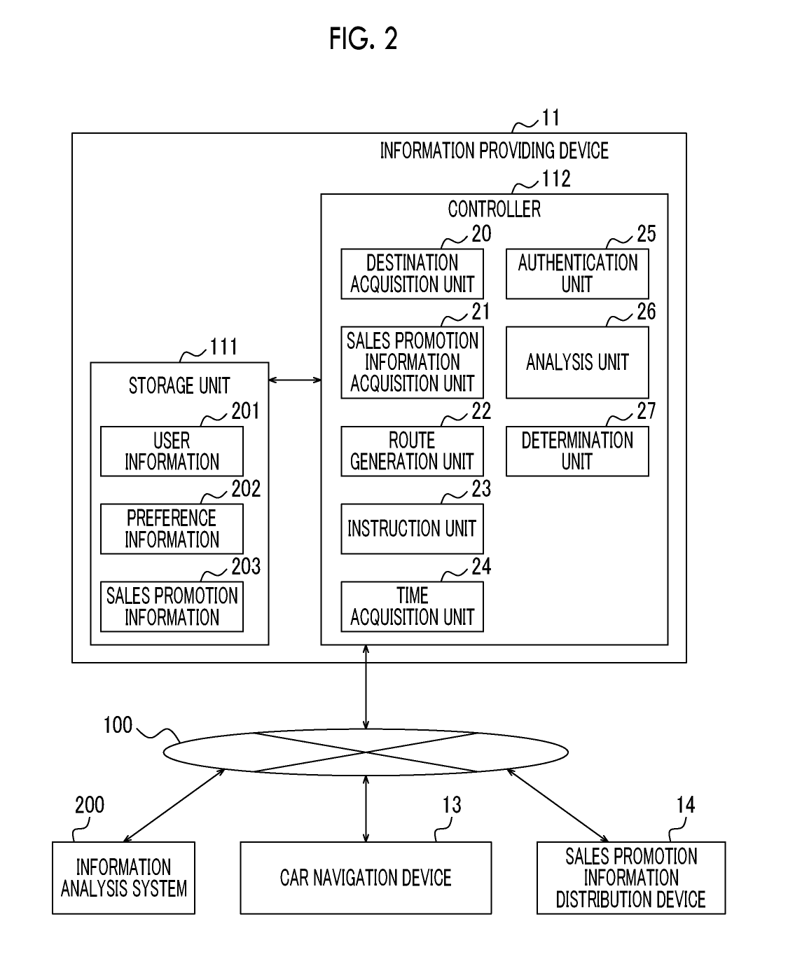

FIG. 2 is a diagram showing a detailed configuration example of the information providing device 11.

The information providing device 11 includes a destination acquisition unit 20, a sales promotion information acquisition unit 21, a route generation unit 22, an instruction unit 23, a time acquisition unit 24, an authentication unit 25, an analysis unit 26, and a determination unit 27. The units are constituted of the controller 112 that executes steps corresponding to the units. The operations of the units will be described below.

In the information providing device 11, the storage unit 111 has user information 201 for specifying the user 16 and preference information 202 relating to the preference of the user 16. The user information 201 is, for example, personal information, such as a user ID, a password, and a name. The personal information may include feature data for authentication, for example, a fingerprint or an iris. The personal information is acquired in advance based on the agreement of the user 16. For example, the user 16 transmits the personal information from the car navigation device 13, the portable terminal 12, or another information processing device to the information providing device 11. The preference information 202 includes, for example, an interest, a preference of activity, a preference of a meal, an action history, and the like. The preference information 202 may be acquired from, for example, an external information analysis system 200. The information analysis system 200 has a result of analysis of the preference of the user 16 based on the agreement of the user 16 from the action history of the user 16, transmission information in a social network service (SNS), or the like. The analysis unit 26 acquires the preference information 202 from the information analysis system 200 through the communication network 100 and stores the preference information 202 in the storage unit 111. With this, it is possible to reduce a burden of an input on the user 16.

The storage unit 111 has sales promotion information 203. The sales promotion information 203 is acquired from the sales promotion information distribution device 14. The sales promotion information acquisition unit 21 receives the sales promotion information 203 from the sales promotion information distribution device 14 and stores the sales promotion information 203 in the storage unit 111.

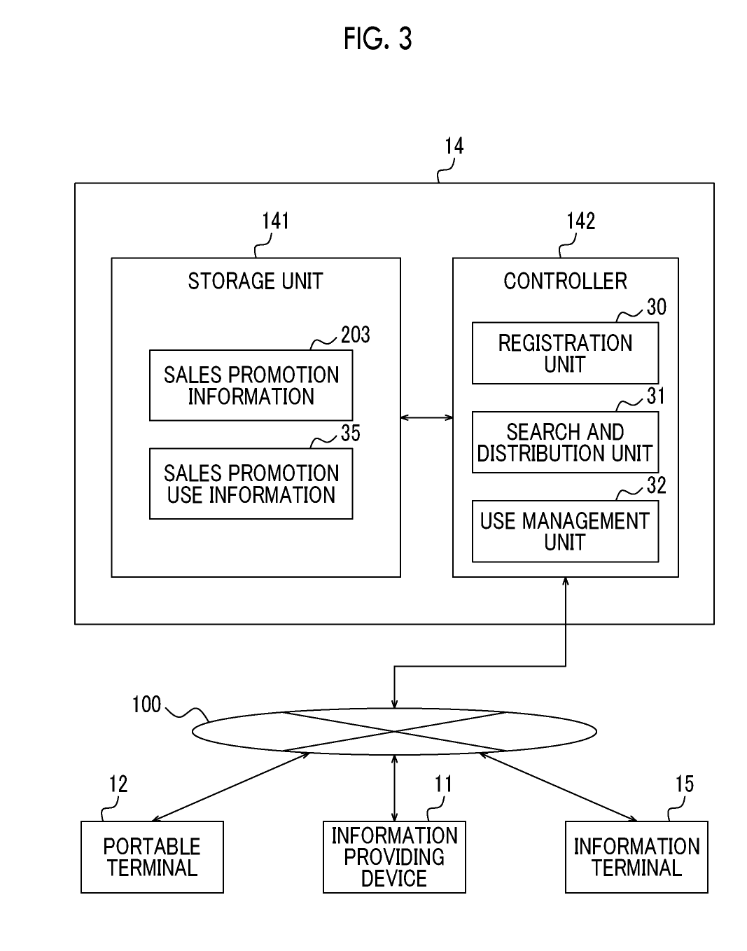

FIG. 3 is a diagram showing a configuration example of the sales promotion information distribution device 14. The sales promotion information distribution device 14 includes a registration unit 30, a search and distribution unit 31, and a use management unit 32. The units are constituted by the controller 142 that executes steps corresponding to the units. The operations of the units will be described below.

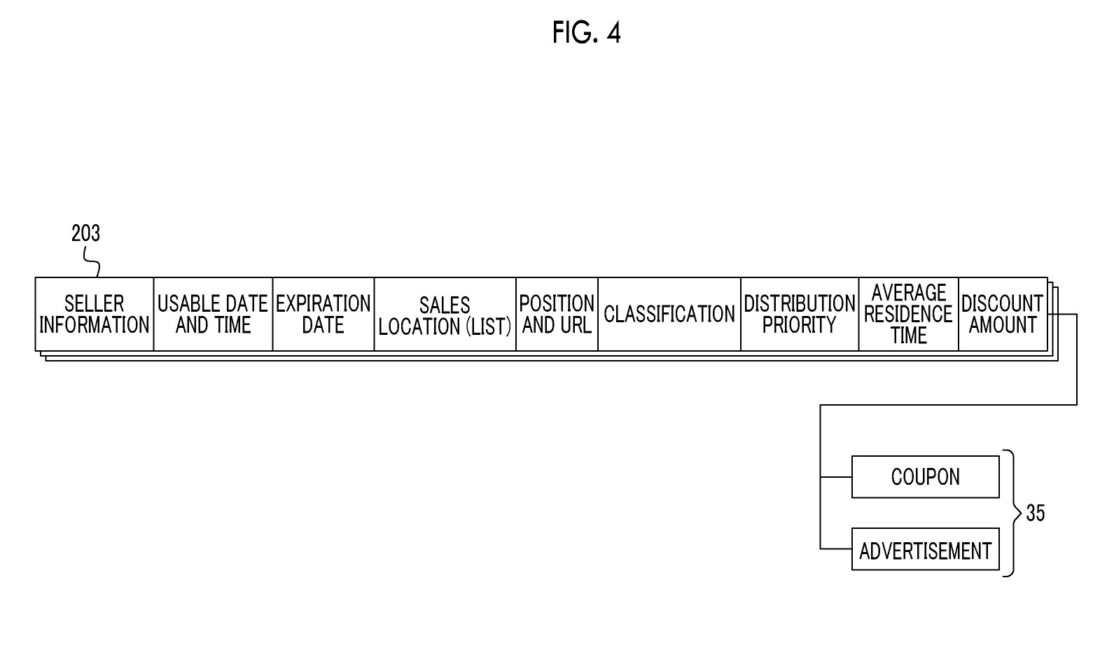

In the sales promotion information distribution device 14, the storage unit 141 has the sales promotion information 203 and sales promotion use information 35. The sales promotion information 203 and the sales promotion use information 35 are acquired from the information terminal 15 of the seller 18. For example, the registration unit 30 stores the sales promotion information 203 and the sales promotion use information 35 transmitted from the information terminal 15 in the storage unit 141. For example, when a request to generate both or one of the sales promotion information 203 and the sales promotion use information 35 is received from the information terminal 15, the registration unit 30 generates both or one of the sales promotion information 203 and the sales promotion use information 35 based on the request and stores the generated information in the storage unit 141. The registration unit 30 makes various kinds of information shown in FIG. 4 including seller information for specifying the seller 18 correspond to the sales promotion information 203.

FIG. 4 is a diagram showing examples of the sales promotion information 203 and the sales promotion use information 35.

The sales promotion information 203 has, for example, seller information, usable date and time (period, day of week, time period, and the like) of the sales promotion use information 35, an expiration date, a list of sales locations, a position or a URL of each sales location, classification of a commodity or a service, distribution priority, an average residence time, and a discount amount are made to correspond to one another. The expiration date is an expiration date for arrival at a sales location, and includes, for example, a business close time of a sales location, an end time of a service to be provided, and a start time of an event to be performed. The classification of the commodity or the service is, for example, data of a tree structure having classifications of different gradings. The classification is, for example, data of information including a large classification, a middle classification, and a small classification, such as “food-Japanese food-sushi”, “food-Japanese food-tempura”, “food-Italian-pasta”, “food-Italian-pizza”, “event-exhibition and spot sale-clothing”, “event-exhibition and spot sale-daily necessities”, “event-show-hero”, and “event-show-idol”. The classification may be a data structure capable of matching the preference information 202, and the grading of information, the number of layers, and the like are not limited to the example shown in the drawing. The distribution priority is, for example, the priority of a distribution order of the sales promotion information set by the registration unit 30. The distribution priority is set in, for example, an order in which the expiration date is close, a registration order of the sales promotion information, or an order of the amount of the undistributed sales promotion information of the same classification. Alternatively, the seller 18 may set the priority optionally at the time of registration. The average residence time is obtained from, for example, a total of times for which an unspecified number of users reside at the sales location. For example, when the sales promotion information 203 is registered in the sales promotion information distribution device 14, the seller 18 sets the average residence time. In addition, the sales promotion information 203 may have an average amount of the commodity or the service and a discount rate at the sales location, instead of the discount amount.

The sales promotion use information 35 is made to correspond to the sales promotion information 203. The sales promotion use information 35 is data of a sales location, a classification, and a coupon for purchasing a commodity or a service with a discount amount corresponding to each piece of sales promotion information. The sales promotion use information 35 is, for example, data for displaying a barcode or a QR code (Registered Trademark) indicating a discount amount. The sales promotion use information 35 is data of an advertisement relating to a sales location, a classification, and a discount amount corresponding to each piece of sales promotion information. The sales promotion use information 35 is, for example, data for displaying a guide map of a sales location or an illustration image of a commodity or a service.

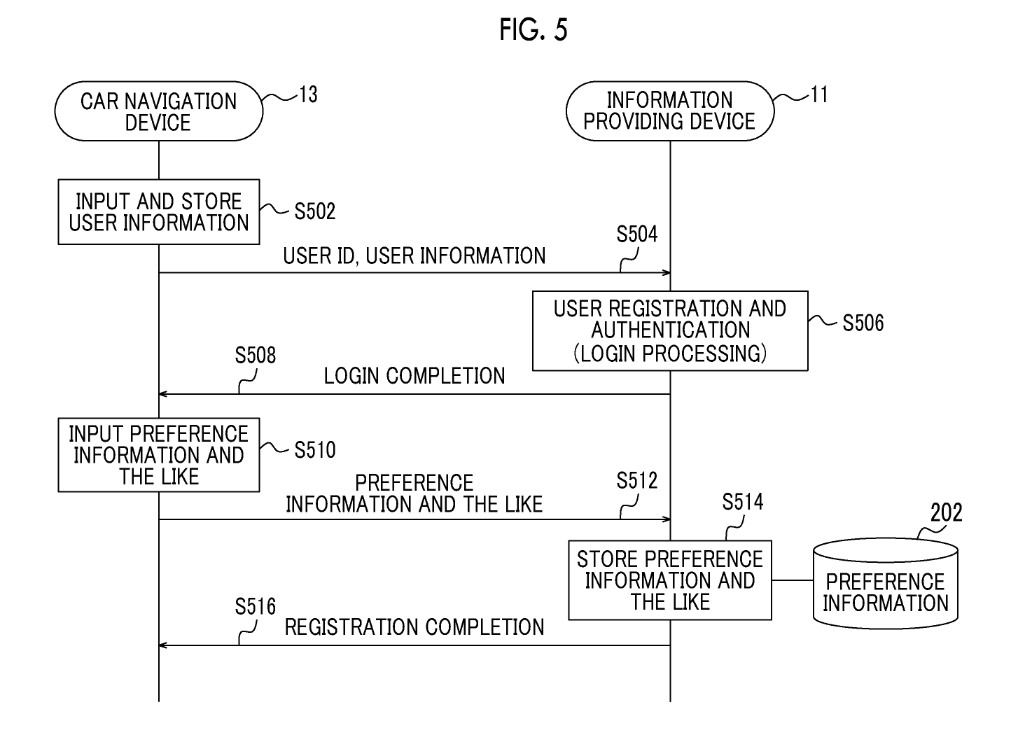

An operation procedure of the information providing device 11 and the like in the embodiment will be described referring to FIGS. 5 to 12B.

FIG. 5 shows a procedure example where the preference information and the like of the user 16 are transmitted to the information providing device 11. The procedure of FIG. 5 is executed, for example, when the user 16 uses the car navigation device 13 for the first time. Here, the procedure is shown with the car navigation device 13 as an example. Note that, in the procedure of FIG. 5, the portable terminal 12 or an information processing device, such as a personal computer, connectable to the communication network 100 may replace the car navigation device 13.

When an input of the user ID and the user information from the user 16 is received and the user information 201 is stored in the storage unit 131 (S502), the car navigation device 13 transmits the user ID and the user information 201 to the information providing device 11 (S504). Thereupon, the information providing device 11 registers or authenticates the user 16 with the user ID to allow the user 16 to login (S506). When the user ID transmitted from the car navigation device 13 is not stored in the storage unit 111 as the user information 201, the information providing device 11 registers the user newly, and when the user ID is already stored, the information providing device 11 allows the user to login as an existing user. Then, the information providing device 11 transmits notification of login completion to the car navigation device 13 (S508). Thereupon, when an input of the preference information from the user 16 is received (S510), the car navigation device 13 transmits the preference information to the information providing device 11 (S512). Then, the information providing device 11 stores the preference information 202 in the storage unit 111 to correspond to the user information 201 (S514), and notifies the car navigation device 13 of registration completion of the preference information 202 (S516).

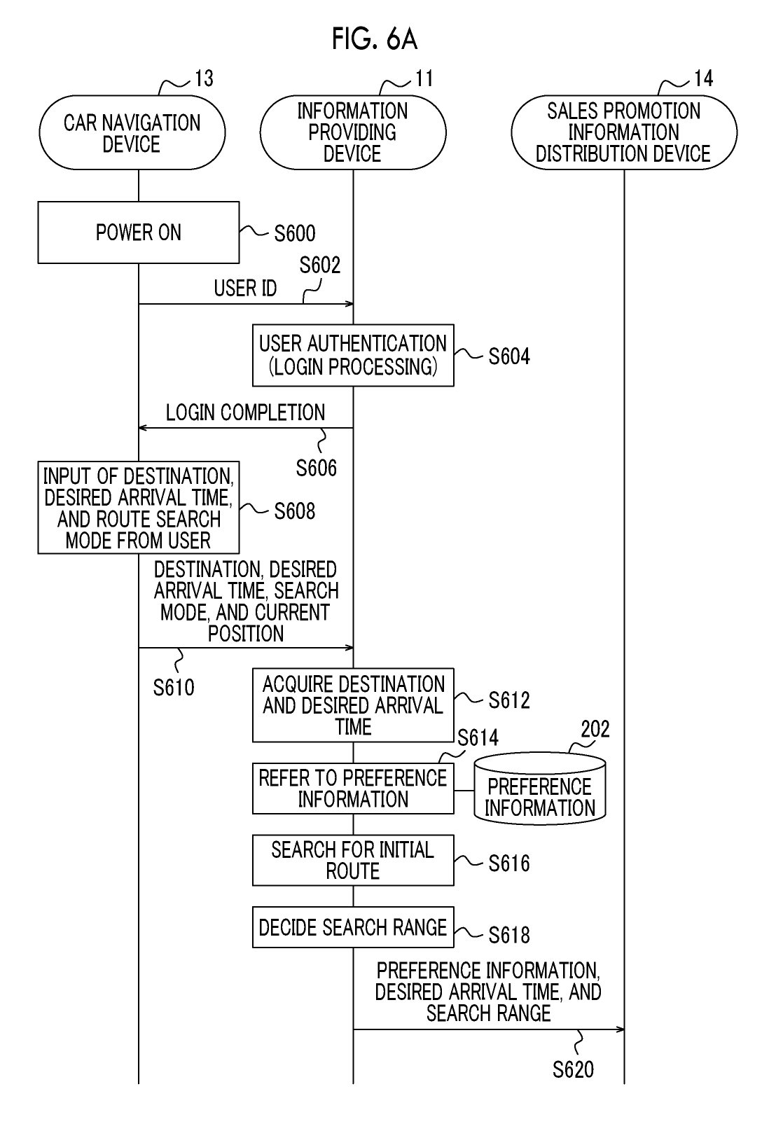

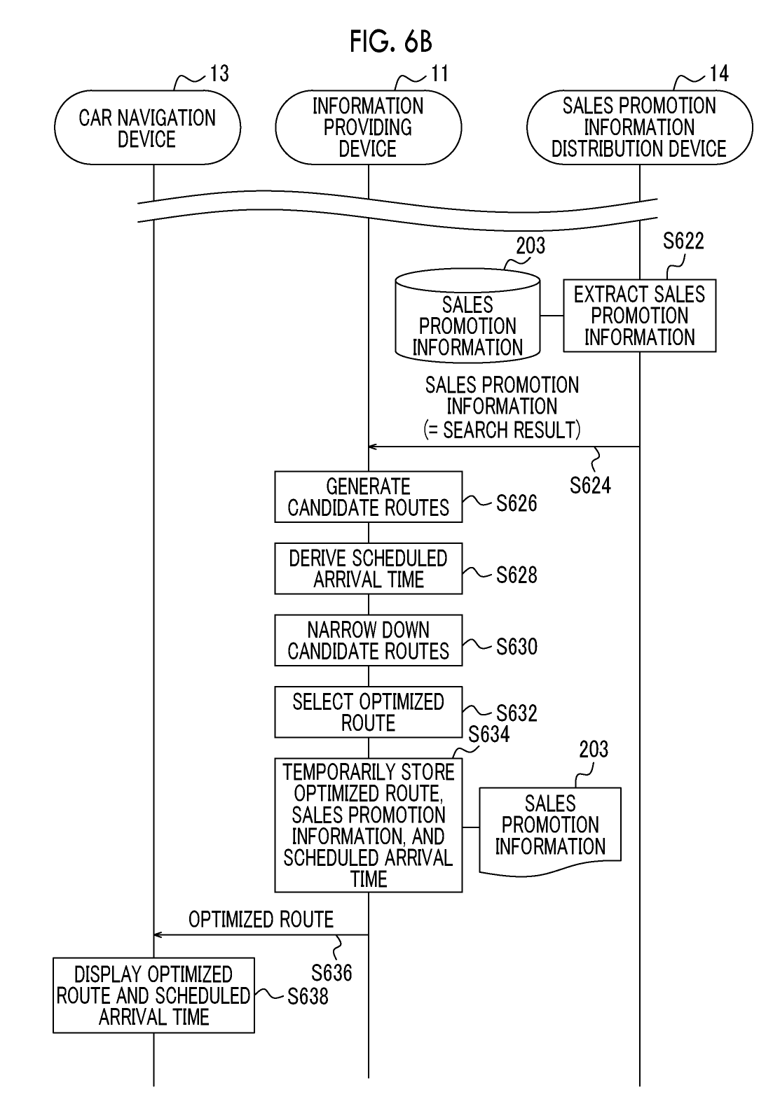

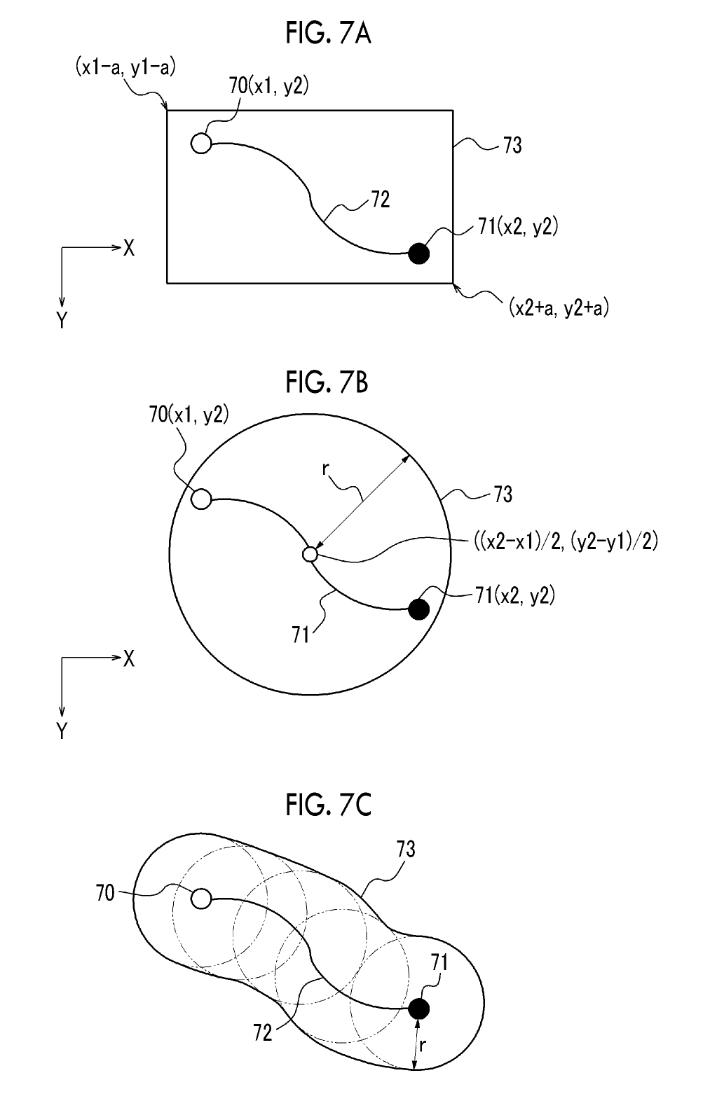

FIGS. 6A and 6B show a procedure example where the information providing device 11 performs route generation. FIGS. 7A, 7B, and 7C are diagrams showing an example of route generation. The procedure of FIGS. 6A and 6B is executed, for example, when the user 16 performs a route search with the car navigation device 13. The procedure when the information providing device 11 performs route generation will be described referring to FIGS. 7A, 7B, and 7C along with FIGS. 6A and 6B.

When power is on by the user 16 (S600), the car navigation device 13 transmits the user ID to the information providing device 11 (S602). The user ID is set by the user 16 at the time of a use start of the car navigation device 13 or the like. Thereupon, the information providing device 11 authenticates the user 16 with the user ID to allow the user 16 to login (S604), and transmits notification of login completion to the car navigation device 13 (S606).

Next, when an input of a destination, a desired arrival time, and a route search mode from the user 16 is received (S608), the car navigation device 13 transmits the destination, the desired arrival time, the route search mode, and a current position to the information providing device 11 (S610). Thereupon, the information providing device 11 acquires the destination and the desired arrival time in the destination acquisition unit 20 and the time acquisition unit 24, respectively (S612). When the destination is not input, the destination acquisition unit 20 may extract the action history of the user 16 from the preference information 202, and may employ, based on the action history, a destination where the user 16 visits in a previous predetermined period most frequently or a destination where the user 16 has visited with last movement. When the information providing device 11 provides a scheduler function to the user 16, the time acquisition unit 24 may suppose and employ a destination from the scheduler based on a current time. In this way, it is possible to reduce a burden of a destination input on the user. Then, the information providing device 11 refers to the preference information 202 of the user stored in the storage unit 111 (S614).

Next, the information providing device 11 executes Steps S616 to S632 with the route generation unit 22. The information providing device 11 searches for any initial route from a departure place to the destination with a current place as the departure place (S616). At this time, the initial route is, for example, the shortest route from the current place to the destination. Alternatively, the initial route may be, for example, a route having the shortest time distance. Alternatively, the initial route may be a route where fuel consumption is minimized. Then, the information providing device 11 decides a search range of a sales location based on an initial route 72 (S618).

FIGS. 7A, 7B, and 7C show an example of a search range 73 to an initial route 72 from a current position 70 to a destination 71. FIG. 7A shows an example of a rectangular search range 73 including the current position 70 and the destination 71. For example, when XY coordinates of the current position 70 and the destination 71 are (x1,y1) and (x2,y2), respectively, and when x1<x2 and y1<y2, the search range 73 is set as a rectangle with (x1-a,y1-a) and (x2+a,y2+a) (where a >0; a is set to any value) as diagonals. FIG. 7B shows an example of a circular search range 73 including the current position 70 and the destination 71 with a midpoint of the current position 70 and the destination 71 as a center. For example, when the XY coordinates of the current position 70 and the destination 71 are (x1,y1) and (x2,y2), respectively, and when x1<x2 and y1<y2, the search range 73 is set as a circle having ((x2−x1)/2,(y2−y1)/2) as a center and a radius r longer than a direct distance from the center to the current position 70 or the destination 71 by a distance b (where b>0; b is set to any value). FIG. 7C shows an example where the search range 73 is within a predetermined distance r from the initial route 72. The predetermined distance is, for example, any distance or time distance. The predetermined distance r is, for example, any distance equal to or less than 5 km or any time distance equal to or less than 10 minutes.

Returning to FIG. 6A, the information providing device 11 transmits the preference information 202, the desired arrival time, and the search range 73 to the sales promotion information distribution device 14 (S620). Referring to FIG. 6B, the sales promotion information distribution device 14 extracts the sales promotion information 203 having the sales location within the search range 73 from the storage unit 141 (S622), and transmits the sales promotion information 203 to the information providing device 11 (S624). In this way, the sales location is restricted within the search range 73, whereby it is possible to avoid waste of time or fuel due to a detour to an extremely far sales location. Here, the information providing device 11 acquires the sales promotion information 203 with the sales promotion information acquisition unit 21. The sales promotion information distribution device 14 selects one piece of sales promotion information 203 from one classification of a commodity or a service and transmits the selected sales promotion information 203 to the information providing device 11, whereby it is possible to avoid duplication of the sales promotion information. The sales promotion information distribution device 14 may exclude the sales promotion information, the expiration date of which is reached, based on a current time. With this, it is possible to reduce a subsequent processing load.

Next, the information providing device 11 generates candidates of a route passing through the sales locations (S626). At this time, the information providing device 11 decides a passing-through order of the sales locations using any method and generates candidate routes. For example, the passing-through order is, for example, a passing-through order of passing through the sales locations in order from a nearest sales location, a passing-through order of passing through the sales locations in order from a sales location at the shortest time distance, an order of passing through the sales locations in an order in which the expiration date corresponding to the sales promotion information 203 is reached, a passing-through order of each permutation generated by the sales locations, a combination thereof, or the like. In particular, when the sales locations are passed through in an order in which the expiration date is reached, the user is highly likely to arrive at the sales locations timely, and it is possible to contribute to the satisfaction of the user. In regard to a route between the sales locations, to the shortest distance route, the shortest time distance route, a route where fuel consumption is minimized, or the like can be set using any method.

Next, the information providing device 11 derives a scheduled arrival time at the destination for each candidate route (S628). A derivation method of the scheduled arrival time may be any method. For example, the scheduled arrival time can be derived using a legal speed limit of each candidate route and a movable speed based on road traffic information or the like. The information providing device 11 adds the average residence time at the sales location included in the sales promotion information 203, thereby deriving the scheduled arrival time with higher accuracy. Then, the information providing device 11 selects candidate routes having the scheduled arrival time before the desired arrival time of the user 16 and narrows down the candidate routes (S630). With this, it is possible to contribute the degree of satisfaction of the user. That is, it is considered that the user does not always like to move the shortest distance and desires to enjoy driving at an unknown location at times. However, it is desirable to avoid a situation in which the user passes through an extremely roundabout route and is too late for the desired arrival time. Accordingly, a route where the desired arrival time of the user is not exceeded is selected, whereby it is possible to satisfy a desire of the user to arrive at the destination before the desired arrival time while satisfying a desire of the user to drive at an unknown location.

Next, the information providing device 11 decides a route according to the search mode acquired from the car navigation device 13 in Step S605 among the candidate routes (S632). For example, the information providing device 11 gives an evaluation value according to the search mode to each candidate route and extracts a route having a maximum evaluation value. A route extracted according to the search mode in this way is referred to as an optimized route for convenience.

Here, the route search mode is, for example, a number-of-sales locations priority mode in which a route for passing the most sales locations is searched. At this time, the information providing device 11 gives the number of passing-through sales locations as the evaluation value to each candidate route and extracts a route having the maximum evaluation value as the optimized route. According to the number-of-sales locations priority mode, it is possible to satisfy a desire of the user to enjoy driving to travel as a large number of locations as possible. At the same time, since it is possible to create an opportunity to use more sales promotion information, it is possible to restrain accumulation of stork of the sales promotion information in the sales promotion information distribution device 14, and to contribute to the profit of a sales promotion information distribution service provider.

The route search mode is, for example, a discount amount priority mode in which a route for maximizing a total of discount amounts at passing-through sales locations is searched. At this time, the information providing device 11 gives the total of the discount amounts at the sales locations through which the route passes as the evaluation value to each candidate route and extracts a route having a maximum evaluation value as the optimized route. When the sales promotion information 203 has the discount rate and the average amount, a discount amount can be derived from the discount rate and the average amount and can be used as the evaluation value. According to the discount amount priority mode, the user can make a good purchase while experiencing driving outside a normal action range. At the same time, through creating an opportunity to use more sales promotion information, it is possible to restrain accumulation of stock of the sales promotion information, and to contribute to the profit of the sales promotion information distribution service provider.

The route search mode is, for example, a preference priority mode in which a route passing through a sales location having a high degree of matching to the preference information 202 of the user 16 is searched. At this time, the information providing device 11 matches the classification of the commodity or the service and the preference information 202 at a sales location through which each candidate route passes, and obtains the degree of matching between the classification and the preference information of the user. Then, the information providing device 11 gives a total value of the degree of matching as the evaluation value of the candidate route and extracts a route having a maximum evaluation value as the optimized route. According to the preference priority mode, the user can visit the sales location of the commodity or the service matching the preference while experiencing driving outside the normal action range. At the same time, through creating an opportunity to use more sales promotion information, it is possible to restrain accumulation of stock of the sales promotion information, and to contribute to the profit of the sales promotion information distribution service provider.

The route search mode is an opportunity priority mode in which a route passing through not only a sales location having a high degree of matching to the preference information of the user 16 but also a sales location having a low degree of matching is searched. At this time, the information providing device 11 obtains the degree of matching between the classification of the commodity or the service and the preference information of the user at a passing-through sales location for each candidate route, gives a total value of the degree of matching as the evaluation value of the candidate route, and extracts a route having the evaluation value equal to or less than a predetermined value as the optimized route. Alternatively, the information providing device 11 may give a total of distribution priority corresponding to the sales promotion information 203 as the evaluation value to the candidate route and may extract a route having a maximum evaluation value as the optimized route. According to the opportunity priority mode, it is possible to efficiently provide even sales promotion information not matching the preference of the user to the user. With this, it is possible to efficiently restrain accumulation of stock of the sales promotion information, and to contribute to the profit of the sales promotion information distribution service provider.

A case where the route search mode is not set is also included in the embodiment. In this case, for example, the information providing device 11 automatically extracts the optimized route in any one of the number-of-sales locations priority mode, the discount amount priority mode, the preference priority mode, and the opportunity priority mode. Alternatively, a record of modes previously selected by the user may be stored in the storage unit 111 to correspond to the user information 201, and a mode most frequently selected within a predetermined period (for example, past one to three months) may be employed to extract the optimized route.

Next, the information providing device 11 stores the optimized route, and the sales promotion information 203 and the scheduled arrival time corresponding to the route in the storage unit 111 (S634), and transmits the optimized route to the car navigation device 13 (S636).

Then, the car navigation device 13 displays the optimized route received from the information providing device 11 along with the scheduled arrival time (S638).

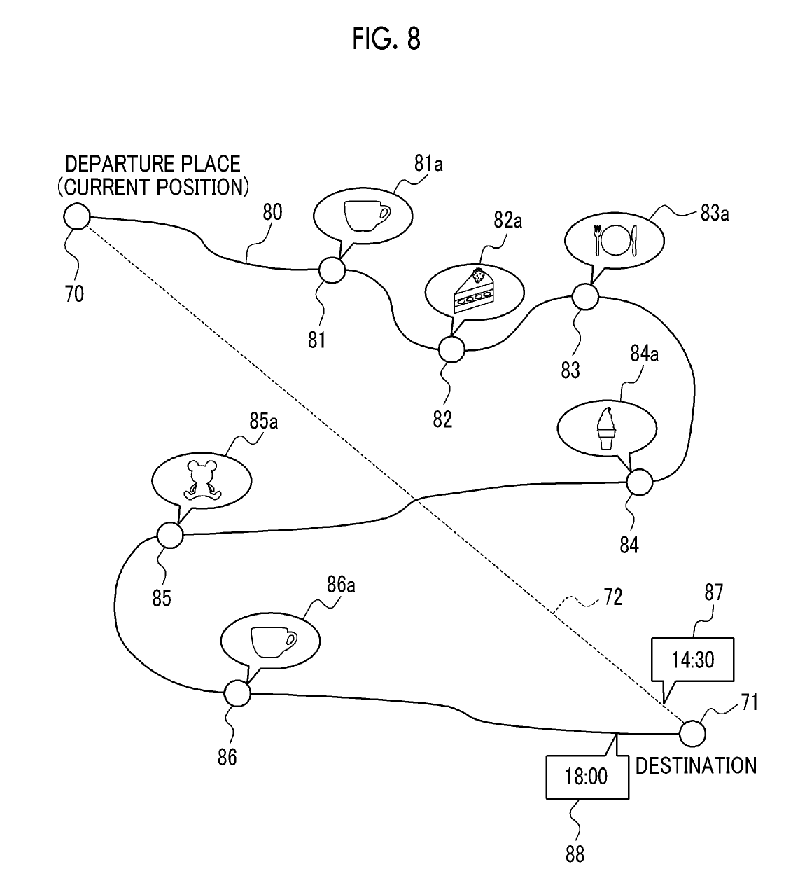

FIG. 8 shows a display example of an optimized route. An optimized route 80 is a route passing through sales locations 81 to 86 with respect to the initial route 72 from the current position 70 to the destination 71. At the sales locations 81 to 86, an icon indicating the classification of the commodity or the service at each sales location is shown. For example, the sales location 81 is displayed along with an icon 81a indicating that a drink is provided at a cafe at a discount. The sales location 82 is displayed along with an icon 82a indicating that sweets are provided at a cafe at a discount. The sales location 83 is displayed along with an icon 83a indicating that a meal is provided at a restaurant at a discount. The sales location 84 is displayed along with an icon 84a indicating that sweets are sold at a convenience store at a discount. The sales location 85 is displayed along with an icon 85a indicating that goods are sold at a shop at a discount. The sales location 86 is displayed along with an icon 86a indicating that a drink is provided at a cafe at a discount.

The car navigation device 13 displays a destination arrival time 87 on the initial route 72, a destination arrival time 88 on the optimized route 80, in addition to the initial route 72, the optimized route 80, and the icons 81a to 86a corresponding to the sales locations 81 to 86.

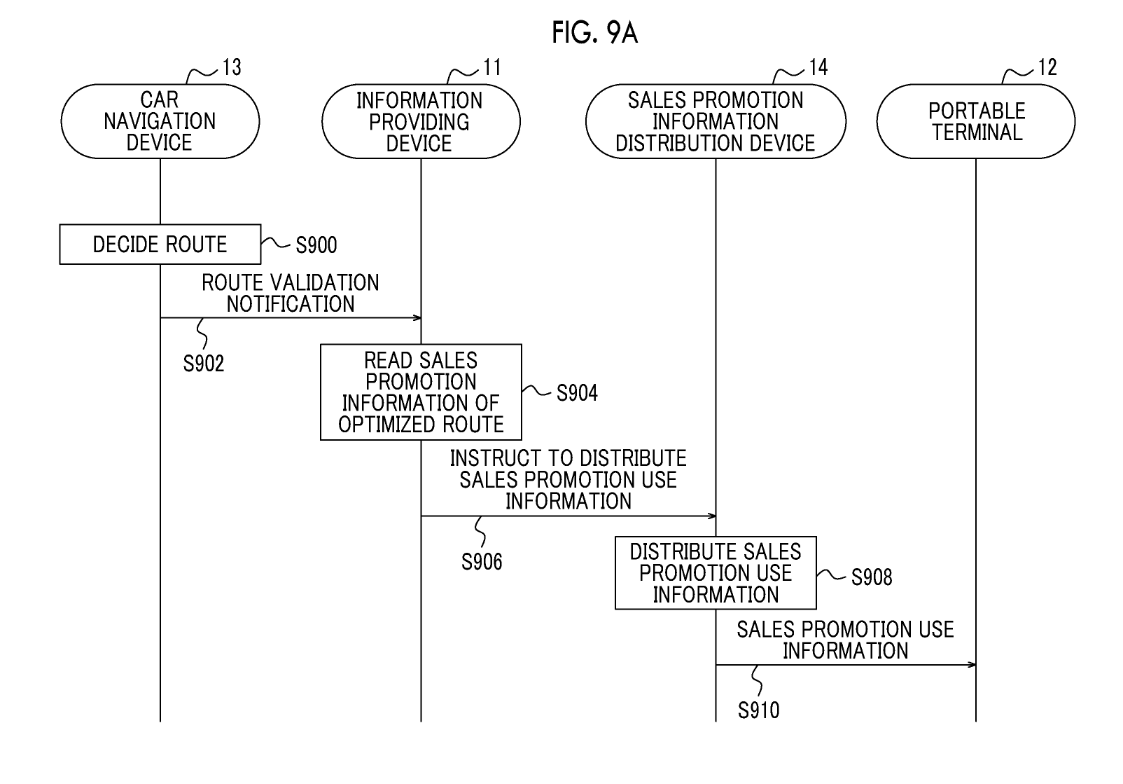

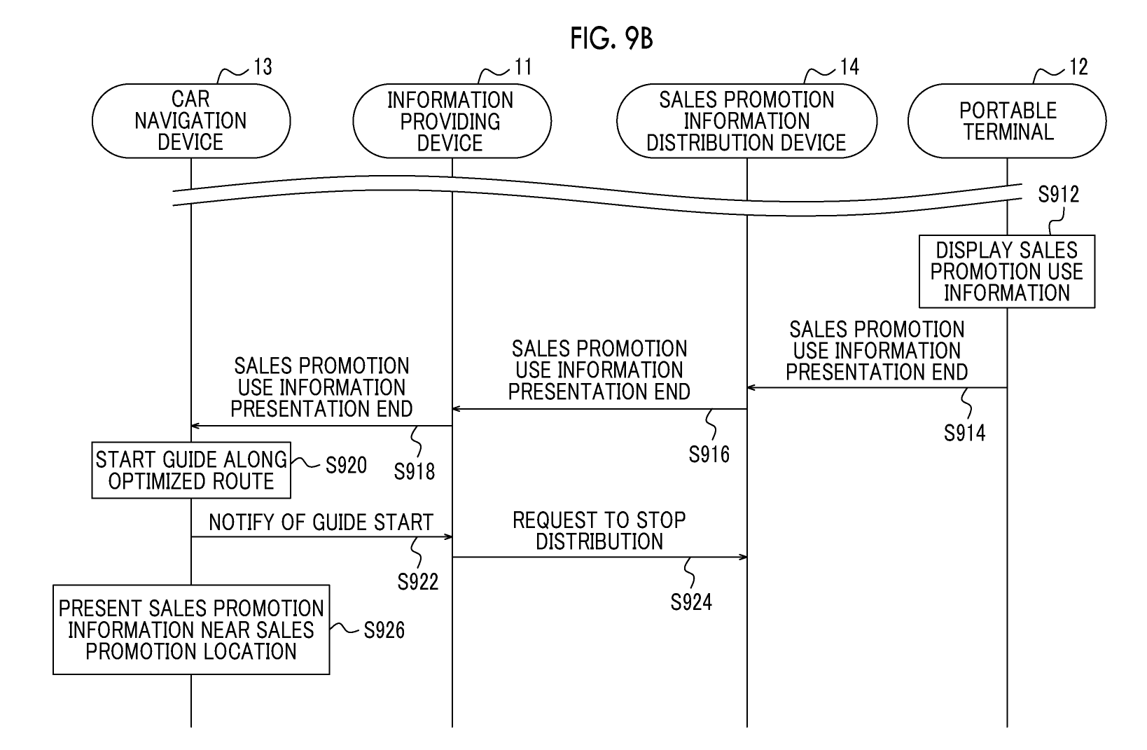

FIGS. 9A and 9B show a procedure example where the sales promotion use information 35 is transmitted to the portable terminal 12. The procedure of FIGS. 9A and 9B is executed next to the procedure of FIGS. 6A and 6B.

In FIG. 9A, when an input to decide the optimized route 80 from the user 16 is received (S900), the car navigation device 13 transmits route validation notification to the information providing device 11 (S902). Thereupon, the information providing device 11 reads the sales promotion information 203 corresponding to the sales locations 81 to 86, through which the optimized route 80 passes, from the storage unit 111 (S904). Next, the information providing device 11 instructs the sales promotion information distribution device 14 to transmit the sales promotion use information 35 at the sales locations 81 to 86, through which the optimized route 80 passes, to the portable terminal 12 with the instruction unit 23 (S906).

In response to the instruction from the information providing device 11, the sales promotion information distribution device 14 transmits the sales promotion use information 35 to the portable terminal 12 (S908, S910). At this time, the sales promotion information distribution device 14 searches for and extracts the sales promotion use information 35 matching the instruction from the information providing device 11 from the storage unit 141 and transmits the extracted sales promotion use information 35 to the portable terminal 12 with the search and distribution unit 31.

Referring to FIG. 9B, the portable terminal 12 displays the sales promotion use information 35 (S912) to present the sales promotion use information 35 to the user 16. The sales promotion use information 35 is, for example, an advertisement or a coupon relating to each of the sales locations 81 to 86. The user 16 views the sales promotion use information 35 and can confirm the contents of sales promotion at the sales locations 81 to 86. The portable terminal 12 notifies the sales promotion information distribution device 14 of presentation end of the sales promotion use information 35 (S914). Thereupon, the sales promotion information distribution device 14 transmits the received notification to the information providing device 11 (S916). Then, the information providing device 11 transmits the received notification to the car navigation device 13 (S918). Thereupon, the car navigation device 13 starts route guidance based on the optimized route 80 (S920).

When route guidance is started, the car navigation device 13 further notifies the information providing device 11 of guidance start (S922). Thereupon, the information providing device 11 requests the sales promotion information distribution device 14 to stop sales promotion information distribution in response to the notification (S924). With this, it is possible to avoid user's confusion due to presentation of sales promotion information out of the optimized route 80 to the user. When a current position of the vehicle 17 is near a sales location (within a distance range set optionally, for example, within 1 km), the car navigation device 13 displays the sales promotion information corresponding to the sales location, for example, the classification of the commodity or the service, and the like (S926). With this, it is possible to improve the convenience of the user.

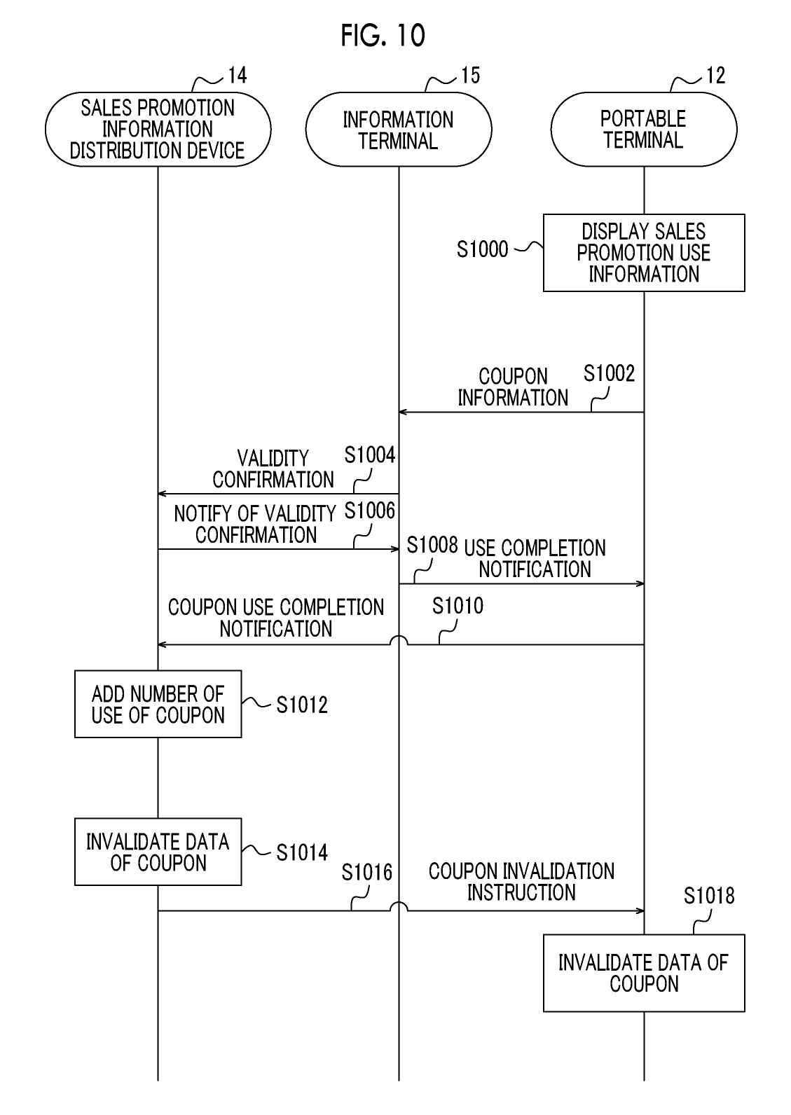

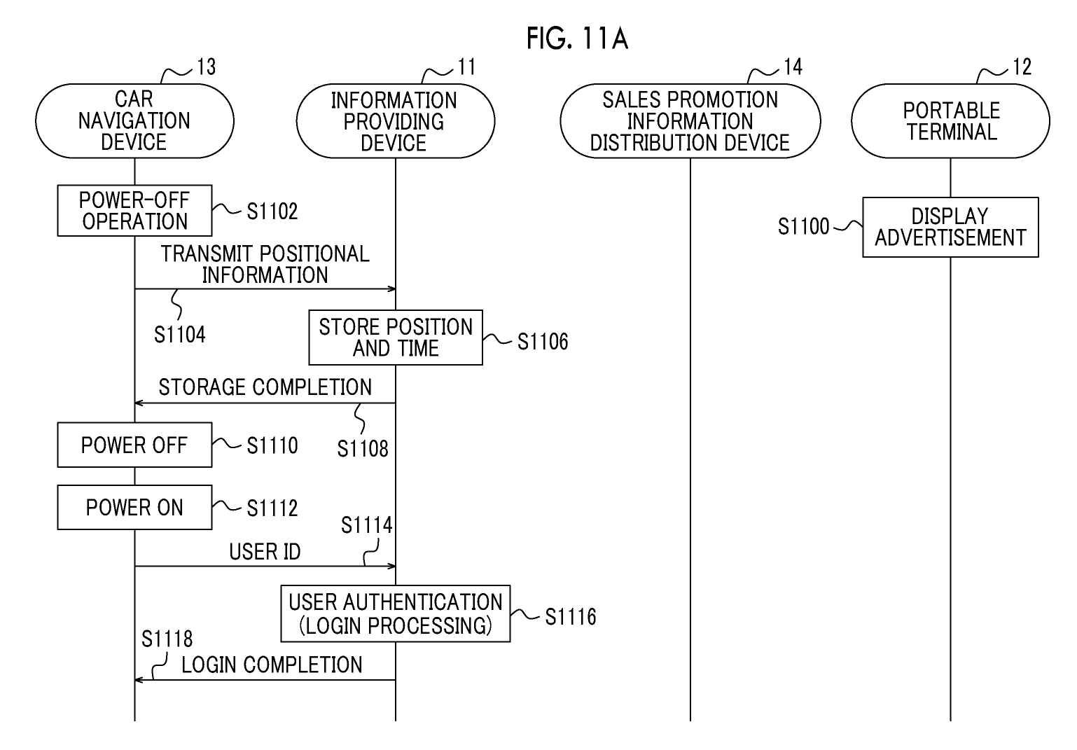

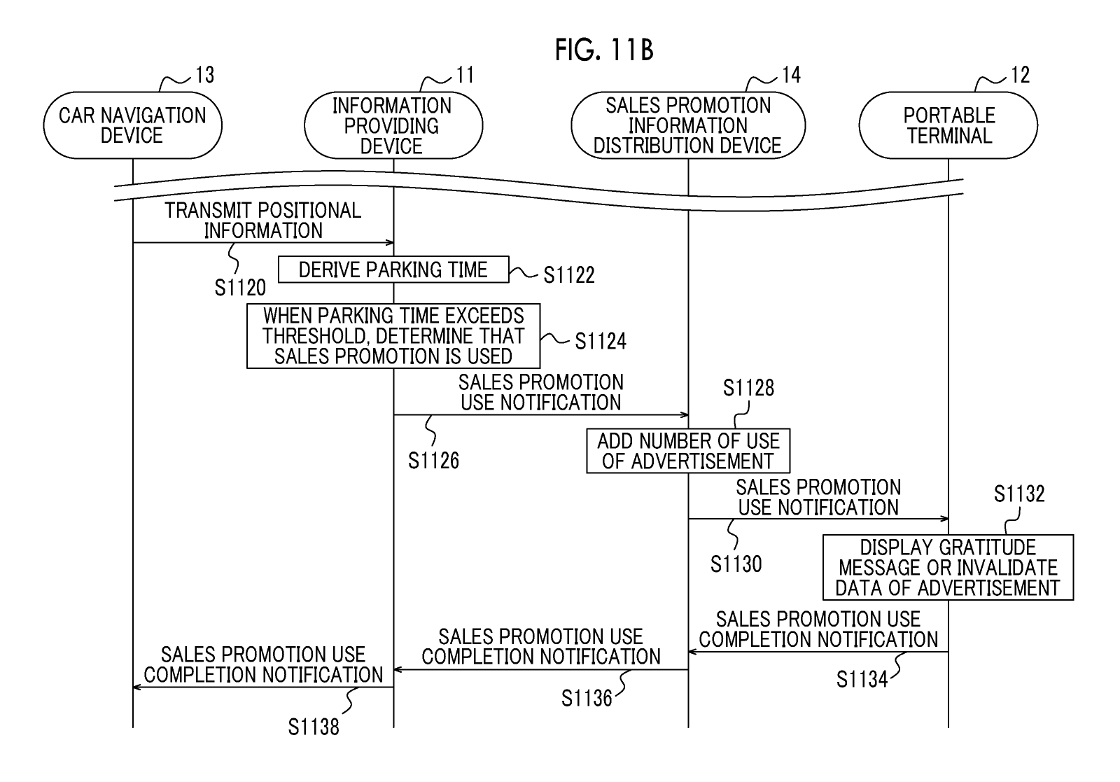

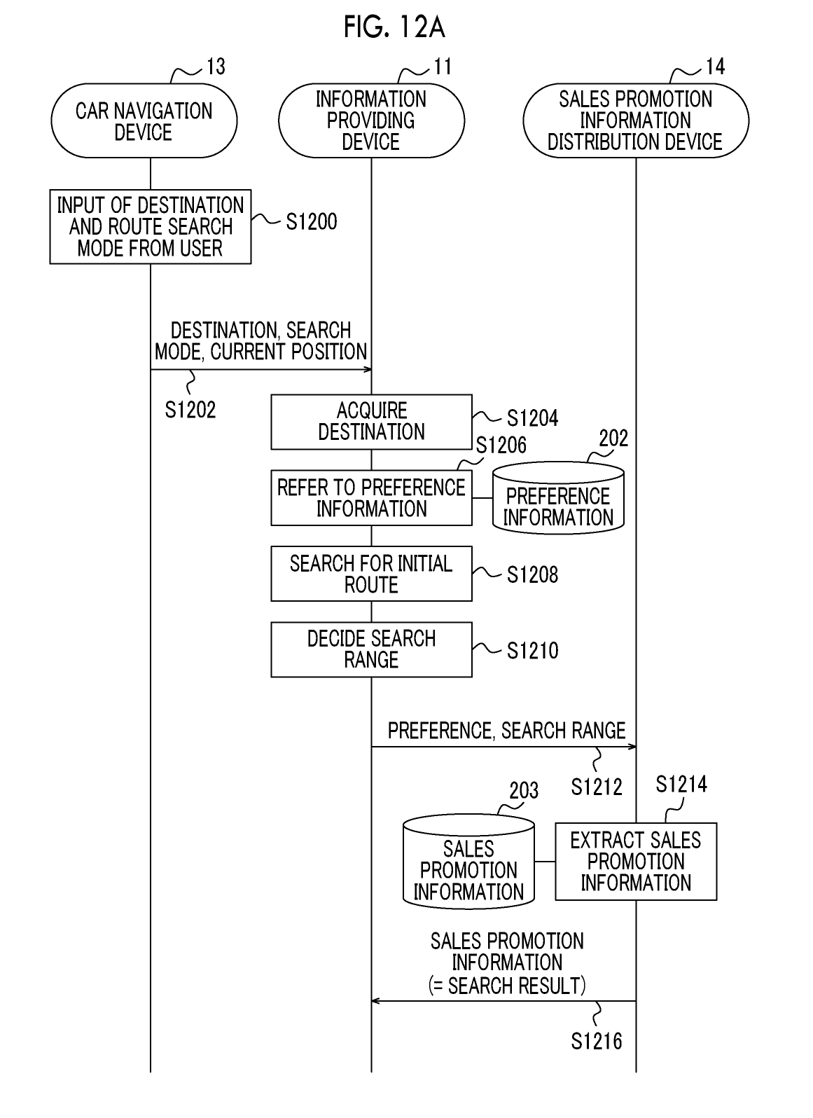

FIGS. 10, 11A, and 11B show a procedure example where the user 16 uses the sales promotion use information 35 with the portable terminal 12. FIG. 10 shows a procedure when the sales promotion use information 35 has a coupon usable at the sales locations 81 to 86. FIGS. 11A and 11B show a procedure when the sales promotion use information 35 has an advertisement. The procedures of FIGS. 10, 11A, and 11B are executed next to the procedure of FIGS. 9A and 9B.

In FIG. 10, a procedure example where the sales promotion use information 35 uses a coupon usable at the sales locations 81 to 86 will be described. The portable terminal 12 displays the sales promotion use information 35, that is, a coupon in response to an operation of the user 16 (S1000). For example, when the user 16 arrives at any one of the sales locations 81 to 86 and purchases a commodity or a service, the user 16 makes the portable terminal 12 display the coupon. The user 16 presents the coupon displayed on the portable terminal 12 to the seller 18, and transmits coupon information from the portable terminal 12 to the information terminal 15 of the seller 18 (S1002). For example, a scanner connected to the information terminal 15 reads an identification code of the coupon, or the portable terminal 12 establishes short-range wireless connection with the information terminal 15 and transmits the coupon information from the portable terminal 12 to the information terminal 15 in a wireless manner.

Next, the information terminal 15 transmits the coupon information to the sales promotion information distribution device 14 and requests for validity confirmation (S1004). The sales promotion information distribution device 14 collates the coupon information received from the information terminal 15 with the sales promotion use information 35 stored in the sales promotion information distribution device 14, confirms the validity of the coupon, and notifies of the confirmation (S1006). Then, the information terminal 15 transmits use completion notification of the coupon to the portable terminal 12 (S1008). Then, the portable terminal 12 transmits the use completion notification of the coupon to the sales promotion information distribution device 14 (S1010). In response to this, the sales promotion information distribution device 14 adds the number of use of the coupon with the use management unit 32 (S1012), and invalidates data of the used coupon (81014). Here, when an agreement is made that the sales promotion information distribution service provider that operates the sales promotion information distribution device 14 pays compensation according to the amount of sales promotion information distributed through the information providing device 11 to an information provider that operates the information providing device 11, the compensation is paid from the sales promotion information distribution service provider to the information provider according to the number of use of the coupon added in Step S1012. Furthermore, at the time of subsequent setting of the optimized route, it is possible to decide the priority of the sales promotion information according to the number of use of the coupon. Then, the sales promotion information distribution device 14 transmits a coupon invalidation instruction to the portable terminal 12 (S1016). Then, the portable terminal 12 invalidates data of the used coupon (S1018), and makes the same coupon unusable.

In FIGS. 11A and 11B, a procedure example where the sales promotion use information 35 has an advertisement will be described. First, in FIG. 11A, the portable terminal 12 displays the sales promotion use information 35, that is, an advertisement in response to an operation of the user 16 (S1100). The user 16 makes the portable terminal 12 display the advertisement, for example, when moving along the optimized route 80. The user 16 views the advertisement and can decide whether or not to purchase a commodity or a service at the sales locations 81 to 86.

When the user 16 arrives at a desired sales location and parks the vehicle 17, and when the user 16 performs a power-off operation to the car navigation device 13, the car navigation device 13 receives the operation (S1102), and transmits positional information at this time to the information providing device 11 (51104). Then, the information providing device 11 stores the positional information and the time at this time in the storage unit 111 (S1106), and notifies the car navigation device 13 of storage completion (S1108). In response to this, the car navigation device 13 turns off the power (S1110).

When the user 16 views, purchases, or the like, for example, a desired commodity or service at the desired sales location, and starts to move again, and when the power of the car navigation device 13 is turned off by the user 16 (S1112), the car navigation device 13 transmits the user ID to the information providing device 11 (S1114). Then, the information providing device 11 authenticates the user 16 with the user ID to allow the user 16 to login (S1116), and transmits notification of login completion to the car navigation device 13 (S1118). Here, the information providing device 11 performs user authentication with the authentication unit 25.

Referring to FIG. 11B, the car navigation device 13 transmits the positional information at this time to the information providing device 11 (S1120). Then, the information providing device 11 derives a parking time from the time at this time and a time at the time of parking stored in Step S1106 with the determination unit 27 (S1122), and when the parking time exceeds a predetermined threshold, determines with the determination unit 27 that sales promotion is used (S1124). The determination that sales promotion is used is, for example, determination that the user who is guided to the advertisement visits the sales location and purchases a commodity or a service and resides at the sales location for a time indicating a high probability of purchasing a commodity or a service. Here, a determination criterion can be set to any time (for example, any time equal to or longer than 15 minutes). Then, the information providing device 11 transmits the sales promotion use notification to the sales promotion information distribution device 14 (S1126).

Then, the sales promotion information distribution device 14 adds the number of use of the advertisement in the use management unit 32 (S1128). Here, when an agreement is made that the sales promotion information distribution service provider that operates the sales promotion information distribution device 14 pays compensation according to the amount of sales promotion information distributed through the information providing device 11 to the information provider that operates the information providing device 11, the compensation is paid from the sales promotion information distribution service provider to the information provider according to the number of use of the advertisement added in Step S1128. Furthermore, at the time of subsequent setting of the optimized route, it is possible to decide the priority of the sales promotion information according to the number of use of the advertisement. Next, the sales promotion information distribution device 14 transmits the sales promotion use notification to the portable terminal 12 (S1130). Then, the portable terminal 12 invalidates data of the used advertisement or displays a gratitude message relating to sales promotion use to the user (S1132), and transmits the sales promotion use completion notification to the sales promotion information distribution device 14 (S1134). Then, the sales promotion information distribution device 14 transmits the sales promotion use completion notification to the information providing device 11 (S1136). Then, the information providing device 11 transmits the sales promotion use completion notification to the car navigation device 13 (S1138).

According to the embodiment, it is possible to efficiently provide the sales promotion information to the user. As a technique related to the embodiment, in an example where the sales promotion information based on the position or preference of the user is presented, it is not possible to provide the sales promotion information at the sales location out of the action range to the user. Then, stock of the sales promotion information occurs in the sales promotion information distribution service provider, and there is a concern that the profit of the provider is pressed. From this point, according to the embodiment, it is possible to efficiently provide even the sales promotion information not matching the action range or the preference of the user to the user. Furthermore, the sales promotion information is registered in the sales promotion information distribution device 14 at any time, whereby it is possible to allow the user to be provided with the sales promotion information not provided in the previous optimized route each time the optimized route is searched.

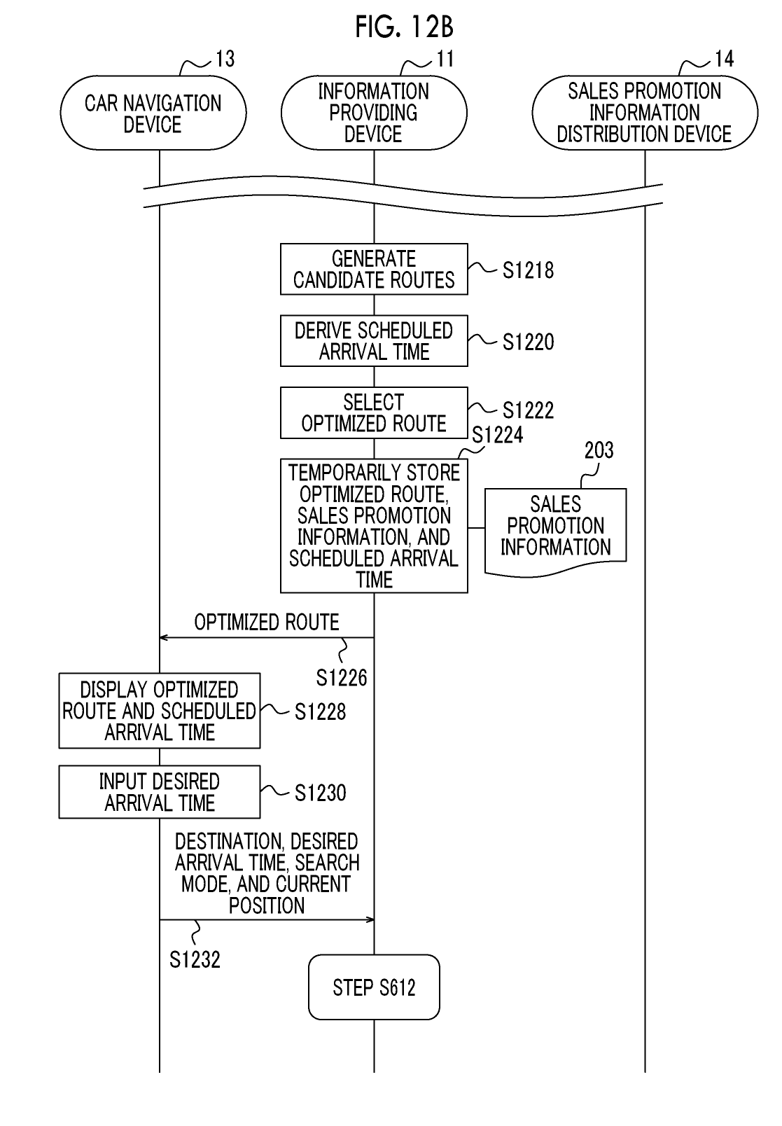

FIGS. 12A and 12B show a procedure example in a modification example of the embodiment. The modification example relates to a case where the desired arrival time of the user is undecided at the time of generating the optimized route. When the car navigation device 13 displays the optimized route 80 generated by the information providing device 11 under a condition no considering the desired arrival time to the user 16 along with the arrival time, the user decides to employ the optimized route based on the desired arrival time. The procedure of FIGS. 12A and 12B is a procedure that is inserted between Steps S603 and S604 of FIG. 6A.

First, in FIG. 12A, when the input of the destination and the route search mode from the user 16 is received (S1200), the car navigation device 13 transmits the destination, the route search mode, and the current position to the information providing device 11 (S1202). Then, the information providing device 11 acquires the destination (S1204), and refers to the preference information 202 of the user stored in the storage unit 111 (S1206).

Next, the information providing device 11 searches for any initial route 72 from the current place (departure place) to the destination (S1208). Then, the information providing device 11 decides the search range 73 of the sales locations based on the initial route 72 (S1210). Next, the information providing device 11 transmits the preference information 202 and the search range 73 to the sales promotion information distribution device 14 (S1212). Then, the sales promotion information distribution device 14 extracts the sales promotion information having the sales locations within the search range 73 from the storage unit 141 (S1214), and transmits the sales promotion information to the information providing device 11 (S1216). Here, the sales promotion information distribution device 14 acquires the sales promotion information with the sales promotion information acquisition unit 21.

Referring to FIG. 12B, the information providing device 11 generates the candidates of the route passing through the sales locations (S1218). At this time, the information providing device 11 decides the passing-through order of the sales locations using any method and generates candidate routes. Then, the information providing device 11 derives the scheduled arrival time at the destination for each candidate route (S1220). Next, the information providing device 11 decides the optimized route 80 according to the search mode acquired from the car navigation device 13 among the candidate routes (S1222). For example, the information providing device 11 gives the evaluation value according to the search mode to each candidate route and extracts the optimized route 80 having the maximum evaluation value.

Next, the information providing device 11 stores the optimized route 80, the sales locations 81 to 86 and the sales promotion information corresponding to the route, and the scheduled arrival time in the storage unit 111 (S1224), and transmits the optimized route 80 to the car navigation device 13 (S1226). Then, the car navigation device 13 displays the optimized route 80 received from the information providing device 11 along with the scheduled arrival time (S1228).

With the above-described procedure, even though the desired arrival time is not decided, the user 16 can examine the displayed optimized route 80 and scheduled arrival time. Then, when the scheduled arrival time is too earlier or later than a desired timing, it is possible to set the desired arrival time again. In this case, the car navigation device 13 receives an input of the desired arrival time from the user 16 (S1230). Then, the car navigation device 13 transmits the destination, the desired arrival time, the route search mode, and the current position to the information providing device 11 (S1232). Then, Step S612 and subsequent steps of FIG. 6A are executed.

In the modification example of the procedure of FIGS. 12A and 12B, a step of estimating the desired arrival time and narrowing down the candidate routes based on the estimated desired arrival time may be inserted between Steps S1220 and S1222. That is, for example, the information providing device 11 adds any time (for example, any time of one to two hours) to the scheduled arrival time in the initial route and estimates the desired arrival time with the route generation unit 22. Then, the information providing device 11 narrows down to the candidate route for arriving at the destination until the estimated desired arrival time. Then, in Step S1226, the information providing device 11 may transmit the estimated desired arrival time to the car navigation device 13 along with the optimized route 80 and the scheduled arrival time, and in Step S1228, the car navigation device 13 may display the estimated desired arrival time along with the optimized route 80 and the scheduled arrival time. With this, even though the desired arrival time is not decided, it is possible to allow the user 16 to compare and examine the estimated desired arrival time and the scheduled arrival time on the optimized route 80. Then, when the estimated scheduled arrival time is too earlier or later than the desired timing, it is possible to set the desired arrival time again, and to search for the optimized route.

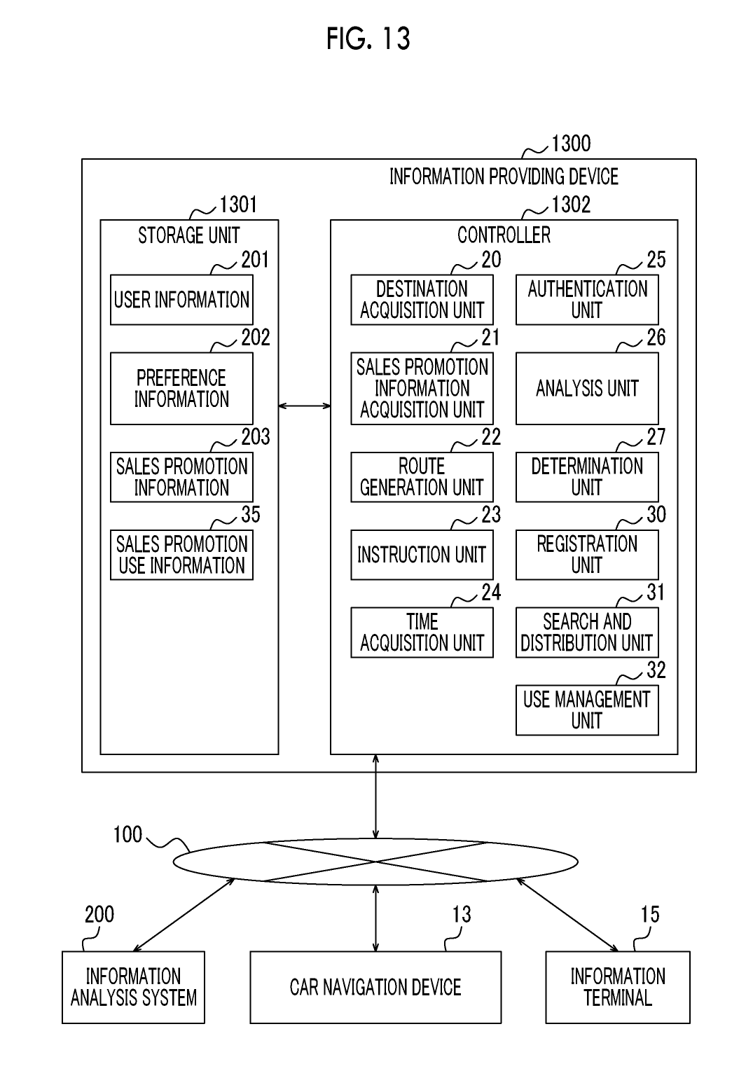

FIG. 13 is a diagram showing a further modification example of the embodiment. In the modification example, the information providing device 11 and the sales promotion information distribution device 14 are integrated as an information providing device 1300. The information providing device 1300 has the functions of both of the information providing device 11 and the sales promotion information distribution device 14. The information providing device 1300 is a server device, and includes a storage unit 1301 and a controller 1302. In the storage unit 1301, the user information 201, the preference information 202, the sales promotion information 203, and the sales promotion use information 35 are stored. The controller 1302 operates as the destination acquisition unit 20, the sales promotion information acquisition unit 21, the route generation unit 22, the instruction unit 23, the time acquisition unit 24, the authentication unit 25, the analysis unit 26, the determination unit 27, the registration unit 30, the search and distribution unit 31, and the use management unit 32. Description of the configurations and operations of the units corresponds to the description of FIGS. 1 to 3. In the description of FIGS. 5 to 12A, and 12B, data communication between the information providing device 11 and the sales promotion information distribution device 14 is construed as data communication between the units in the information providing device 1300, whereby the description of FIGS. 5 to 12A, and 12B is applied to the modification example.

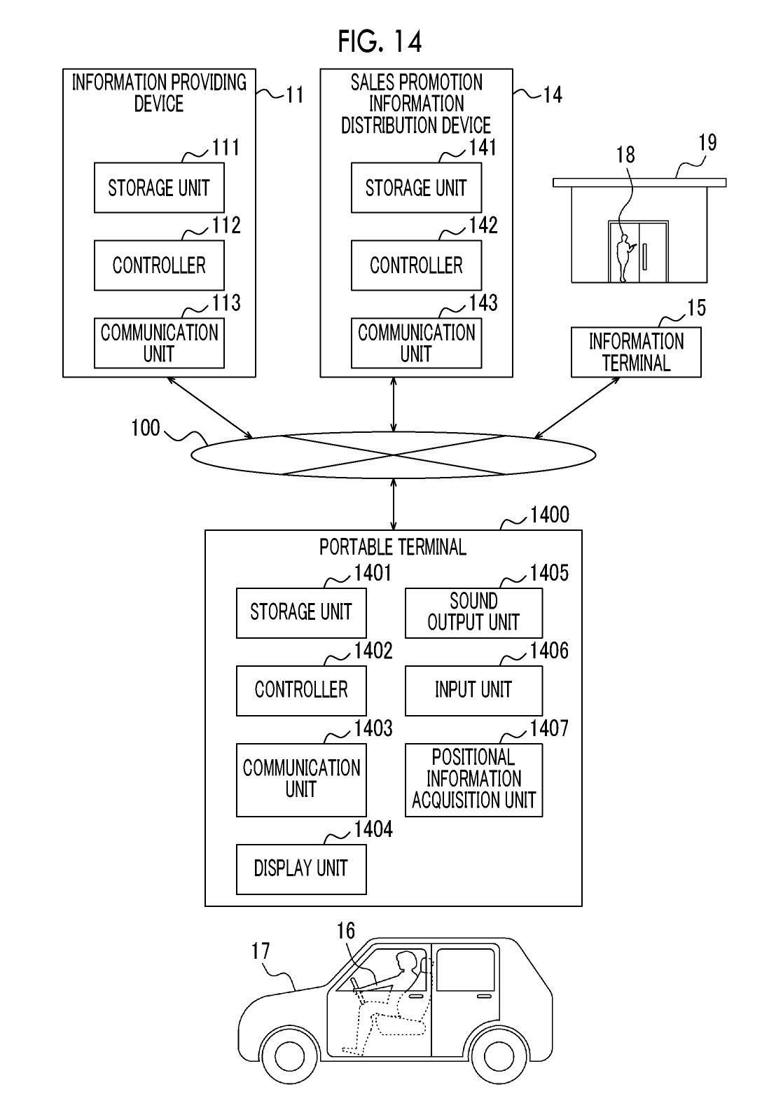

FIG. 14 is a diagram showing a further modification example of the embodiment. In the modification example, the portable terminal 12 and the car navigation device 13 are integrated as a portable terminal 1400. The portable terminal 1400 is a portable information and communication terminal, such as a smartphone or a tablet, including the same functions as the car navigation device 13. The portable terminal 1400 includes a storage unit 1401, a controller 1402, a communication unit 1403, a display unit 1404, a sound output unit 1405, an input unit 1406, and a positional information acquisition unit 1407 corresponding to the storage unit 121, the controller 122, the communication unit 123, the display unit 124, the sound output unit 125, the input unit 126, and the positional information acquisition unit 127 of the portable terminal 12, respectively. Then, the storage unit 1401, the controller 1402, the communication unit 1403, the display unit 1404, the sound output unit 1405, the input unit 1406, and the positional information acquisition unit 1407 function as the storage unit 131, the controller 132, the communication unit 133, the display unit 134, the sound output unit 135, the input unit 136, and the positional information acquisition unit 137 of the car navigation device 13, respectively. For example, the user carries the portable terminal 1400, provides the portable terminal 1400 in front of a driver's seat or the like when driving the vehicle, and uses the portable terminal 1400 as the car navigation device. Description of the configurations and operations of the units corresponds to the description of FIG. 1. In the description of FIGS. 5 to 12A, and 12B, the operation procedures of the portable terminal 12 and the car navigation device 13 are construed as the operation procedure of the portable terminal 1400, whereby the description of FIGS. 5 to 12A, and 12B is applied to the modification example.

In a further modification example, the collaborative operation of the information providing device 11 and the car navigation device 13 shown in FIGS. 5 to 12A, and 12B may be configured, for example, such that any part of the operation of the information providing device 11 may be performed by the car navigation device 13.

Although the embodiment has been described based on the drawings and the example, it should be noted that those skilled in the art can easily make various modifications and corrections based on the present disclosure. Accordingly, it should be noted that such modifications and corrections are included in the scope of the present disclosure. For example, the functions and the like included in respective means or respective steps can be rearranged as long as there is no logical contradiction, and two or more means or steps may be combined into single means or step or may be divided.

Many aspects of the embodiment are shown as a series of operations to be executed by hardware such as a computer system capable of executing program commands. Note that examples of hardware such as a computer system include, in addition to the above-described example, a general-purpose computer, a personal computer, a dedicated computer, a workstation, a personal communications system (PCS; personal mobile communication system), a mobile (cellular) phone, a mobile phone with a data processing function, an RFID receiver, a laptop computer, a tablet computer, and a programmable data processing device. Alternatively, various operations may be executed by a dedicated circuit implemented by a program command, a logic block or a program module that is executed by one or more processors, or the like. Here, examples of one or more processors include any combination of one or more microprocessors, a central processing unit (CPU), an application specific integrated circuit (ASIC), a digital signal processor (DSP), a programmable logic device (PLD), a field programmable gate array (FPGA), a processor, a controller, a microcontroller, a microprocessor, and the like. The memory can be provided inside or outside a processor or a processing unit. The term “memory” means all types of memories including a long term memory, a short term memory, a volatile memory, a nonvolatile memory, and other memories, and the type, the number of memories, and the type of medium in which a memory is stored are not limited.

Examples of the communication network in the present disclosure include, in addition to the above-described example, an ad hoc network, a local area network (LAN), a metropolitan area network (MAN), a cellular network, a wireless personal area network (WPAN), a public switched telephone network (PSTN), a terrestrial wireless network, an optical network, other networks, and any combination thereof. In the constituent elements of the wireless network, an access point (for example, a Wi-Fi access point), a femtocell, and the like are included. In addition, wireless communication equipment can be connected to a wireless network using Wi-Fi (Registered Trademark), Bluetooth (Registered Trademark), a cellular communication technique, or other wireless techniques and technique standards.

The input interface of the input unit includes a keyboard, a touch screen, a pointing device, and the like, but is not limited thereto.

As described above, various aspects of the present disclosure may be implemented as various embodiments, which are all included in the scope of the embodiment.

What is claimed is:

1. An information providing device comprising:
a destination acquisition unit configured to acquire a destination;
a sales promotion information acquisition unit configured to acquire sales promotion information including a sales location where sales promotion is performed;
a route generation unit configured to generate a route from a departure place toward the destination by way of the sales location within a search range including the departure place and the destination, and present the route to a user; and
an instruction unit configured to output an instruction to transmit sales promotion use information for using the sales promotion at the sales location, through which the route passes, to a portable terminal of the user.

2. The information providing device according to claim 1, further comprising a time acquisition unit configured to acquire a desired arrival time at the destination,
wherein the route generation unit generates the route for enabling arrival at the destination before the desired arrival time.

3. The information providing device according to claim 2, wherein:
the sales promotion information includes an average residence time at the sales location; and
the time acquisition unit obtains a scheduled arrival time at the destination based on the average residence time.

4. The information providing device according to claim 1, wherein the sales promotion use information includes a coupon usable at the sales location or an advertisement relating to the sales location.

5. The information providing device according to claim 1, wherein:
the sales promotion information includes an expiration date; and
the route generation unit generates the route to enable arrival at the sales location before the expiration date is reached.

6. The information providing device according to claim 1, wherein, in generating the route, the route generation unit uses a sales location where sales promotion corresponding to preference information of the user is performed.

7. The information providing device according to claim 1, wherein, in generating the route, the route generation unit further uses a sales location where sales promotion not corresponding to preference of the user is performed.

8. The information providing device according to claim 1, wherein the route generation unit generates the route to pass through the most passable sales locations.

9. The information providing device according to claim 1, wherein:
the sales promotion information includes discount information at the sales location; and
the route generation unit generates the route such that a sum of discount amounts at the sales locations, through which the route passes, becomes greater.

10. The information providing device according to claim 1, further comprising a determination unit configured to determine that the user has been at the sales location.

11. The information providing device according to claim 1, wherein the destination acquisition unit obtains the destination based on a movement history of the user.

12. An information providing system comprising:
a portable terminal of a user, and
an information providing device configured to perform communication with the portable terminal, wherein:
the information providing device includes
a destination acquisition unit configured to acquire a destination,
a sales promotion information acquisition unit configured to acquire sales promotion information including a sales location where sales promotion is performed,
a route generation unit configured to generate a route from a departure place toward the destination by way of the sales location within a search range including the departure place and the destination, and present the route to the user, and
an instruction unit configured to output an instruction to transmit sales promotion use information for using the sales promotion at the sales location, through which the route passes, to the portable terminal of the user; and
the portable terminal includes a communication unit configured to receive the sales promotion use information.

13. An information providing method that is executed by a portable terminal of a user and an information providing device configured to perform communication with the portable terminal, the information providing method comprising:
with the information providing device, acquiring a destination, acquiring sales promotion information including a sales location where sales promotion is performed, generating a route from a departure place toward the destination by way of the sales location within a search range including the departure place and the destination, and presenting the route to the user, and outputting an instruction to transmit sales promotion use information for using the sales promotion at the sales location, through which the route passes, to the portable terminal of the user; and
with the portable terminal, receiving the sales promotion use information.
